(19) United States
(12) Patent Application Publication
(10) Pub. No.: US 2025/0360775 A1
(43) Pub. Date: Nov. 27, 2025

(54) VEHICLE CONTROL APPARATUS AND METHOD THEREOF

(71) Applicants: Hyundal Motor Company, Seoul (KR); Kia Corporation, Seoul (KR)

(72) Inventors: Ha Kyung Kim, Hwaseong-Si (KR); Dong II Yang, Hwaseong-Si (KR); Eun Young Choi, Hwaseong-Si (KR); Uk II Yang, Hwaseong-Si (KR); Hyeon Kyu Yang, Hwaseong-Si (KR); So La Chung, Hwaseong-Si (KR)

(21) Appl. No.: 18/960,682

(22) Filed: Nov. 26, 2024

(30) Foreign Application Priority Data
May 24, 2024 (KR) 10-2024-0068044

(51) Int. Cl. B60H 1/00

(52) U.S. Cl. CPC B60H 1/00892; B60H 1/00735; B60H 1/00971

(57) ABSTRACT

A vehicle control apparatus and a method thereof are provided. The vehicle control apparatus includes a memory storing a program instruction and a processor that executes the program instruction. The processor controls a temperature of at least one warmer for emitting heat to the inside of a vehicle, based on at least one of a need for a user to intervene in driving of the vehicle, a driving function of automatically controlled in the vehicle, an event detected while the vehicle is driving, or information of the user, or any combination thereof.

### CROSS-REFERENCE TO RELATED APPLICATION

The present application claims priority to Korean Patent Application No. 10-2024-0068044, filed May 24, 2024, the entire contents of which are incorporated herein by reference for all purposes.

### TECHNICAL FIELD

The present disclosure relates to a vehicle control apparatus and a method thereof, and more particularly, relates to technologies for a warmer for emitting heat to the inside of a vehicle.

### BACKGROUND

A vehicle is loaded with an air conditioner for adjusting an interior temperature of a vehicle. Additionally or alternatively, the interior temperature of the vehicle may be adjusted, using a heating element provided in an interior material of the vehicle, other than the air conditioner in the vehicle. Furthermore, the surface temperature of the interior material of the vehicle with which the body of the user may come into contact increases to decrease discomfort that the user may feel if coming into contact with the cold interior material.

As such, to increase the temperature of the interior material of the vehicle to adjust the interior temperature of the vehicle, the temperature of the interior material of the vehicle may be maintained as a high temperature. At this time, if the body of the user comes into contact with the interior material at the high temperature, there is a risk of burns to the user.

Additionally or alternatively, if the accident of the vehicle occurs in the state in which the temperature of the interior material of the vehicle is maintained as the high temperature, there is also a risk of additional injury.

For example, if the vehicle is traveling in a state in which the function associated with autonomous driving is activated, there is a need for a function capable of properly controlling the temperature of the interior material of the vehicle to ensure the safety of the user.

The matters described in this Background section are only for enhancement of understanding of the background of the disclosure, and should not be taken as acknowledgment that they correspond to prior art already known to those skilled in the art.

### SUMMARY

The present disclosure has been made to solve the above-mentioned problems occurring in the prior art while advantages achieved by the prior art are maintained intact.

An aspect of the present disclosure provides a vehicle control apparatus for decreasing a temperature of a warmer with which a body of a user may come into contact, depending on an automation level while a vehicle is traveling and an event which occurs while the vehicle is traveling, to prevent the user from contacting the body with the warmer at a high temperature and having a burn and a method thereof.

Another aspect of the present disclosure provides a vehicle control apparatus for controlling a temperature of a warmer with which a body of a user may come into contact, depending on a body type of the user, an intention of the user, or a change in posture of the user, to provide the user with comfort and a method thereof.

Another aspect of the present disclosure provides a vehicle control apparatus for properly controlling a temperature of a warmer, depending on an automation level while a vehicle is traveling and an event which occurs while the vehicle is traveling, to create a pleasant indoor environment and a method thereof.

Another aspect of the present disclosure provides a vehicle control apparatus for automatically controlling a temperature of a warmer depending on a driving situation to operate the temperature of the warmer as a high temperature in a situation in which a special event does not occur and a method thereof.

Another aspect of the present disclosure provides a vehicle control apparatus for adjusting a temperature of a warmer, depending on an automation level while a vehicle is traveling and an event which occurs while the vehicle is traveling, to comply with regulations associated with autonomous driving and a method thereof.

The technical problems to be solved by the present disclosure are not limited to the aforementioned problems, and any other technical problems not mentioned herein will be clearly understood from the following description by those skilled in the art to which the present disclosure pertains.

A vehicle control apparatus may comprise: a memory storing a program instruction; and a processor configured to execute the program instruction to cause the vehicle control apparatus to: during autonomous driving of a vehicle, detect, based on sensing data received from at least one sensor of the vehicle, a satisfaction of a temperature adjustment condition of at least one warmer installed in the vehicle, wherein the satisfaction of the temperature adjustment condition of the at least one warmer is detected based on at least one of: a need for a user of the vehicle to intervene in driving of the vehicle; a driving function of automatically controlled in the vehicle; a traffic event detected while the vehicle is driving; or pose information of the user; and control, based on the detected satisfaction of the temperature adjustment condition, a temperature of the at least one warmer, wherein the at least one warmer is configured to transfer heat to an inside of the vehicle.

The processor may be configured to control the temperature of the at least one warmer by: controlling the temperature of the at least one warmer, based on the traffic event being a traffic event associated with one of a plurality of risk levels, wherein the plurality of risk levels are classified according to different risk levels of an expected accident.

The processor may be configured to: detect the traffic event based on at least one of: a detection result of a front side of the vehicle, a detection result of lateral sides of the vehicle, a detection result of a rear side of the vehicle, whether the vehicle enters an intersection, a detection result of a lane change of the vehicle, whether the user takes his or her hands off from a steering wheel, or a detection result of monitoring the user.

The processor may be configured to: control the temperature of the at least one warmer in a first mode, based on the traffic event corresponding to a first risk level of the plurality of risk levels; control the temperature of the at least one warmer in a second mode, based on the traffic event corresponding to a second risk level of the plurality of risk levels; or control a system for controlling the temperature of the at least one warmer to be turned off, based on the traffic event corresponding to a third risk level of the plurality of risk levels.

The processor may be configured to control the temperature of the at least one warmer by: decreasing the temperature of the at least one warmer by a first predetermined value or decreasing the temperature of the at least one warmer to a first temperature, based on controlling the temperature of the at least one warmer in a first mode; and decreasing the temperature of the at least one warmer by a second predetermined value greater than the first predetermined value or decreasing the temperature of the at least one warmer to a second temperature smaller than the first temperature, based on controlling the temperature of the at least one warmer in a second mode.

The processor may be configured to: after controlling the temperature of the at least one warmer, adjust the temperature of the at least one warmer back to a temperature before controlling the temperature of the at least one warmer, based on the traffic event corresponding to at least one risk level of the plurality of risk levels being no longer detected.

The processor may be configured to: maintain the temperature of the at least one warmer at a third temperature, based on at least one of: determining that a body of the user comes into contact with the at least one warmer depending on a body type of the user or determining that the user touches the body of the user with the at least one warmer; or temporarily adjust the temperature of the at least one warmer to a fourth temperature or temporarily turn off a system for controlling the temperature of the at least one warmer, based on determining that the body of the user temporarily comes into contact with the at least one warmer.

The processor may be configured to control the temperature of the at least one warmer by: controlling a temperature of a warmer with which a body of the user comes into contact among the at least one warmer.

The processor may be configured to control the temperature of the at least one warmer by: controlling the temperature of the at least one warmer, using at least one of: a cooling fan, a blower, or compressed gas.

The processor may be configured to control the temperature of the at least one warmer by: controlling the temperature of the at least one warmer with which a body of the user comes into contact, based on at least one of: lateral acceleration occurring by driving of the vehicle or longitudinal acceleration occurring by the driving of the vehicle.

The processor may be configured to set the temperature of the at least one warmer, based on a database in which information about a temperature preferred by the user is registered.

The processor may be configured to set the temperature of the at least one warmer, based on at least one of: information of a high-definition map, driving environment information, or weather information.

The processor may be configured to identify an automation level of the vehicle among a plurality of automation levels, based on at least one of: the need for the user to intervene in the driving of the vehicle or the driving function of automatically controlled in the vehicle.

The processor may be configured to control the temperature of the at least one warmer to be turned off, based on at least one of: a need for a user to intervene in driving of the vehicle, a driving function of automatically controlled in the vehicle, a traffic event detected while the vehicle is driving, or pose information of the user.

A vehicle control method performed by an apparatus of a vehicle may comprise: determining a driving state of the vehicle; during autonomous driving of the vehicle, detecting, based on sensing data received from at least one sensor of the vehicle, a satisfaction of a temperature adjustment condition of at least one warmer installed in the vehicle, wherein the satisfaction of the temperature adjustment condition of the at least one warmer is detected based on at least one of: a need for a user of the vehicle to intervene in driving of the vehicle, a driving function of automatically controlled in the vehicle, a traffic event detected while the vehicle is driving, or pose information of the user; and controlling, based on the detected satisfaction of the temperature adjustment condition, a temperature of at least one warmer, wherein the at least one warmer is configured to transfer heat to an inside of the vehicle.

The apparatus of the vehicle may perform one or more operations and implement one or more features described herein.

### BRIEF DESCRIPTION OF THE DRAWINGS

The above and other objects, features and advantages of the present disclosure will be more apparent from the following detailed description taken in conjunction with the accompanying drawings:

FIG. 1 shows an example block diagram showing a vehicle control apparatus according to an example of the present disclosure.

FIG. 2 shows an example drawing showing a type of a warmer, a temperature of which is controlled by a vehicle control apparatus according to an example of the present disclosure.

FIG. 3 shows an example table in which an automation level of a vehicle is defined, in conjunction with a vehicle control apparatus according to an example of the present disclosure.

FIG. 4A shows an example drawing showing an example of controlling a temperature of a warmer using a blower in a vehicle control apparatus according to an example of the present disclosure.

FIG. 4B shows an example drawing showing an example of controlling a temperature of a warmer using a cooling fan in a vehicle control apparatus according to an example of the present disclosure.

FIG. 4C shows an example drawing showing an example of controlling a temperature of a warmer using compressed gas in a vehicle control apparatus according to an example of the present disclosure.

FIG. 5 shows an example drawing showing an example of a structure of a warmer, a temperature of which is controlled by a vehicle control apparatus according to an example of the present disclosure.

FIG. 6 shows an example block diagram showing a detailed example of a vehicle control apparatus and a warmer system according to an example of the present disclosure.

FIG. 7 shows an example drawing showing an example of a process of controlling a temperature of a warmer based on an event which occurs while a vehicle is driving in a vehicle control apparatus according to an example of the present disclosure.

FIG. 8 shows an example table showing an example of determining a risk level and a control strategy based on an event which occurs in automation level LEVEL 2 in a vehicle control apparatus according to an example of the present disclosure.

FIG. 9 shows an example table showing an example of determining a risk level and a control strategy based on an event which occurs in automation level LEVEL 3 in a vehicle control apparatus according to an example of the present disclosure.

FIG. 10 shows an example table showing an example of determining a risk level and a control strategy based on an event which occurs in automation level LEVEL 4 or above in a vehicle control apparatus according to an example of the present disclosure.

FIG. 11 shows an example drawing showing an example of a direction of acceleration capable of being considered if a vehicle control apparatus according to an example of the present disclosure controls a temperature of a warmer.

FIG. 12 shows an example flowchart for describing a vehicle control apparatus or a vehicle control method.
according to an example of the present disclosure.

FIG. 13 shows an example flowchart for describing an example of differently controlling a temperature of a warmer for each risk level, in conjunction with a vehicle control apparatus or a vehicle control method according to an example of the present disclosure.

FIG. 14 shows an example flowchart for describing a detailed example of differently controlling a temperature of a warmer for each risk level, in conjunction with a vehicle control apparatus or a vehicle control method according to an example of the present disclosure.

FIG. 15 shows an example drawing showing a computing system associated with a vehicle control apparatus or a vehicle control method according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Particularly, the expression “at least one of A, B, or C, or any combination thereof” may include “A”, “B”, or “C”, or “AB”, “BC”, “AC”, or “ABC”, which is a combination thereof.

Specifically, for purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

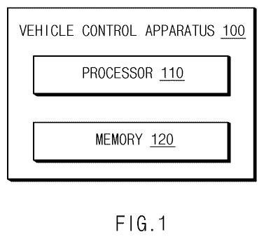

Hereinafter, examples of the present disclosure will be described in detail with reference to FIGS. 1 to 15.

FIG. 1 shows an example block diagram showing a vehicle control apparatus according to an example of the present disclosure.

Referring to FIG. 1, a vehicle control apparatus 100 according to an example of the present disclosure may be implemented in a vehicle. In this case, the vehicle control apparatus 100 may be integrally configured with control units in the vehicle or may be implemented as a separate device to be connected with the control units of the vehicle by a separate connection means.

According to an example, the vehicle control apparatus 100 may include a processor 110 and a memory 120. The components of the vehicle control apparatus 100, which are shown in FIG. 1, are illustrative, and examples of the present disclosure are not limited thereto. For example, the vehicle control apparatus 100 may further include components which are not shown in FIG. 1.

According to an example, the memory 120 may store a command or data. For example, the memory 120 may store one instruction or two or more instructions, if executed by the processor 110, causing the vehicle control apparatus 100 to perform various operations.

According to an example, the memory 120 may be implemented with the processor 110 as one chipset and may store various pieces of information associated with the vehicle control apparatus 100. For example, the memory 120 may store information about an operation history of the processor 110.

According to an example, the memory 120 may include a non-volatile memory (e.g., a read only memory (ROM)) and a volatile memory (e.g., a random access memory (RAM)). For example, information associated with an automation level, information associated with an event for determining a risk level, information associated with a temperature of a warmer controlled according to the risk level, or the like may be stored in the memory 120.

According to an example, the processor 110 may control a temperature of at least one warmer for emitting heat to the inside of the vehicle, based on at least one of a need for a user to intervene in driving of the vehicle, a driving function of automatically controlled in the vehicle, an event detected while the vehicle is driving, or information of the user, or any combination thereof. According to an example, the processor 110 may identify an automation level of the vehicle according to at least one of the need for the user to intervene in the driving of the vehicle or the driving function of automatically controlled in the vehicle, or any combination thereof among a plurality of automation levels.

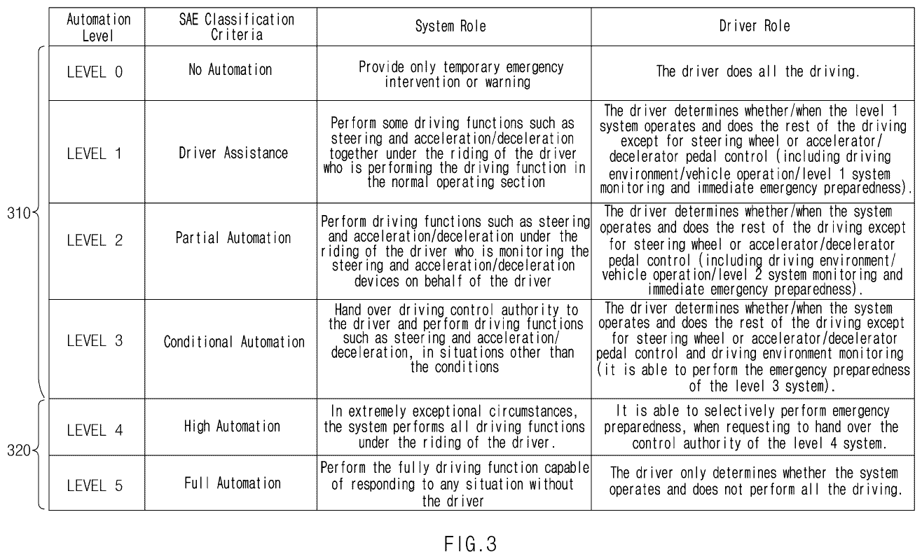

For example, the plurality of automation levels may be included in an example of an automation level shown in FIG. 3. In detail, the plurality of automation levels may be divided based on a role of an autonomous driving system or a role of a driver.

For example, if there is no need for the user to always hold the steering wheel, there is a need for the user to intervene in the steering wheel only in emergency, and the autonomous driving system of the vehicle automatically controls the driving function, such as steering and acceleration and deceleration, the processor 110 may identify the automation level of the vehicle as LEVEL 3.

For example, if the autonomous driving system of the vehicle automatically controls the driving function, such as steering and acceleration and deceleration, in the most situation and it is required for the user to intervene in driving only in a special situation, the processor 110 may identify the automation level of the vehicle as LEVEL 4.

According to an example, the processor 110 may control the temperature of the at least one warmer for emitting the heat to the inside of the vehicle, based on at least one of an event detected while the vehicle is driving, a function of the vehicle, which is executed according to the event, movement of the user, or a posture of the user, or any combination thereof and the automation level of the vehicle.

According to an example, the processor 110 may control the temperature of the at least one warmer for emitting the heat to the inside of the vehicle, based on information of the user, which includes information about movement of the user, a posture of the user, whether the user takes his or her hands off the steering wheel, the result of monitoring the user, a temperature preferred by the user, a body type of the user, or the like.

According to an example, the at least one warmer for emitting the heat to the inside of the vehicle may refer to a part of a vehicle, which includes a heating element for emitting heat.

For example, the warmer may include an interior material of the vehicle, which has a heating function. For example, the interior part of the vehicle, which has the heating function, may include a crash pad, a seat, a glove box, a console box, a door trim, an arm rest for seat, interior flooring of the vehicle, a glass window, or the like.

For example, the warmer may include a control unit of the vehicle, which is loaded with the heating function. For example, the control unit of the vehicle, which is loaded with the heating function, may include a steering wheel, a change gear, a turn signal, a brake pedal, an accelerator pedal, or the like.

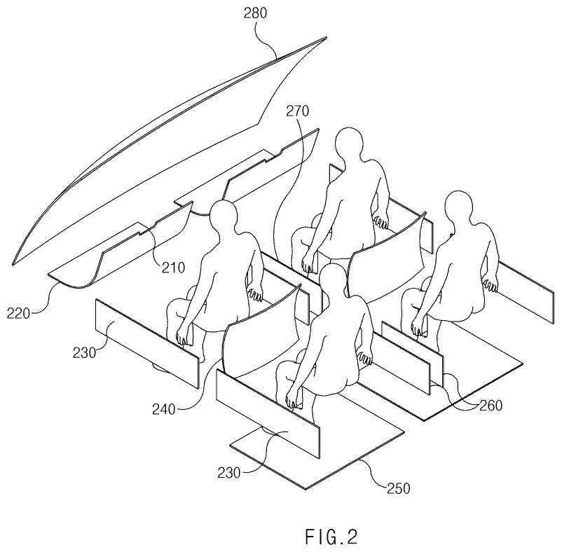

According to an example, the at least one warmer may include various types of warmers shown in FIG. 2.

According to an example, the at least one warmer may have a structure shown in FIG. 5. For example, the warmer may have a structure including at least one of an injection-molded material, an insulation layer, a heating element, a sensor, or a skin material, or any combination thereof.

According to an example, the warmer may emit heat in various schemes. For example, the warmer may emit heat in a radiation scheme, a conduction scheme, or a convection scheme.

According to an example, the temperature of the warmer, which is controlled by the processor 110, may be set by the user or a system.

For example, the processor 110 may increase the temperature of the warmer to a high temperature to increase an interior temperature of the vehicle in a specific condition or a specific situation. The processor 110 may differently control the temperature of the warmer for each type or position of the warmer.

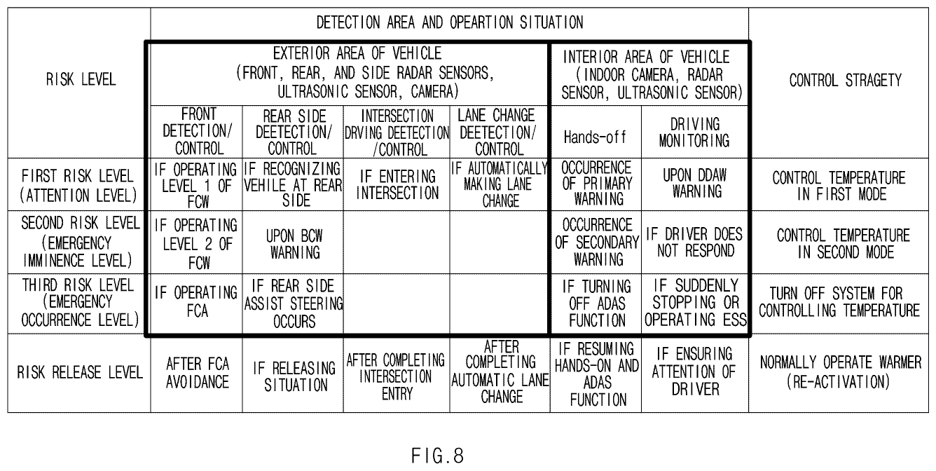

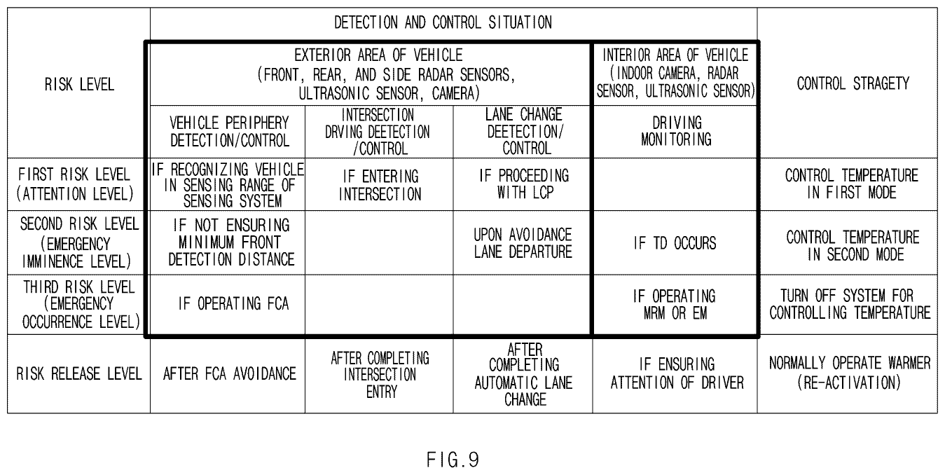

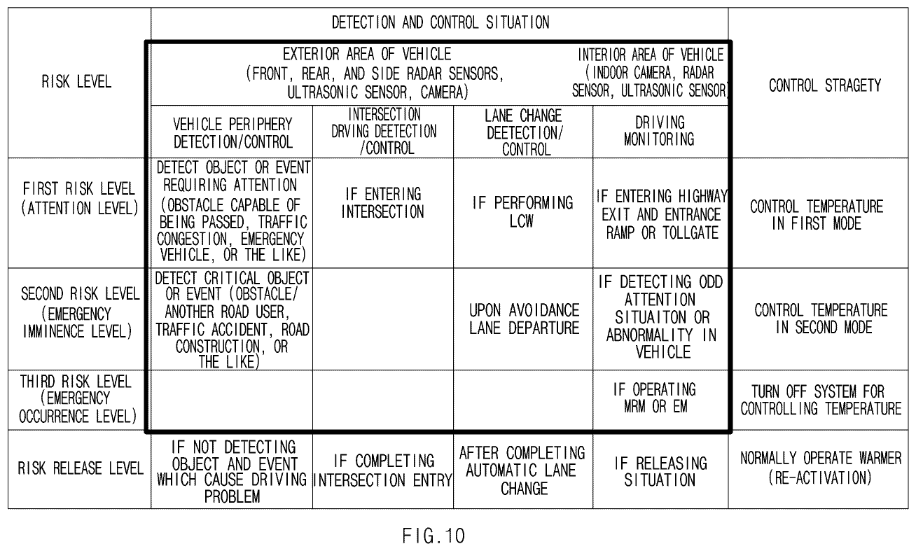

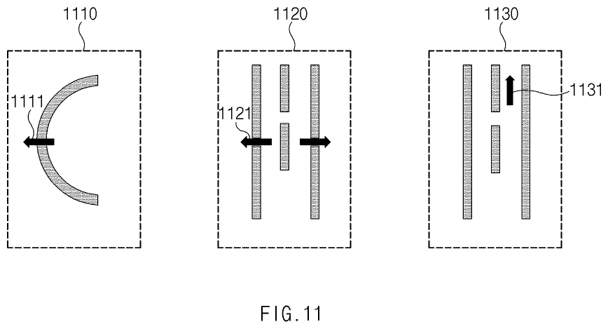

According to an example, the event detected while the vehicle is driving or the function of the vehicle, which is executed according to the event, may include events and functions of the vehicle, which may be exemplified in FIG. 8, FIG. 9, and/or FIG. 10.

According to an example, the event detected while the vehicle is driving may include detecting another vehicle using a front sensor of the vehicle. For example, the event detected while the vehicle is driving may include detecting that the vehicle enters an intersection. For example, the event detected while the vehicle is driving may include detecting that the vehicle attempts to make a lane change.

According to an example, the function of the vehicle, which may be executed according to the event, may include a forward collision warning (FCW) function or a forward collision-avoidance assist (FCA) function, which is executed as another vehicle is detected by the front sensor of the vehicle. For example, a forward collision warning (FCW) function may comprise a safety system designed to alert drivers of an impending collision with a vehicle or object in their path. Using sensors such as radar, cameras, or lasers, the FCW function may continuously monitor the road ahead and calculate the distance and speed of vehicles or obstacles in front of a vehicle. If the safety system detects a potential collision, it may provide a driver with an audible, visual, and/or haptic alert to avoid the collision. For example, a forward collision-avoidance assist (FCA) function may comprise an advanced driver assistance system designed to help prevent or mitigate frontal collisions by automatically applying the brakes if a potential collision is detected. Using a combination of sensors, including radar and cameras, the FCA function may monitor the road ahead to detect vehicles and/or pedestrians in the vehicle's path. If the system senses an impending collision and the driver does not respond in time to warnings, it may automatically engage the brakes to reduce the vehicle's speed, potentially avoiding the collision or minimizing the impact.

For example, the function of the vehicle, which may be executed according to the event, may include a transition demand (TD) function, a minimum risk maneuver (MRM) function, an emergency maneuver (EM) function, or the like, which may be executed according to monitoring a driver.

For example, a transition demand (TD) function may comprise a safety feature in advanced driver assistance systems that may prompt the driver to take back control if a vehicle encounters a situation it may not handle autonomously. The TD function may activate to alert a driver that their intervention is required, for example, in certain driving scenarios, such as complex road conditions, severe weather, or system limitations, etc. The safety system may provide clear visual, audible, and/or haptic alerts, giving the driver sufficient time to prepare to regain full control of the vehicle. The TD function is useful for ensuring safe handover between automated driving modes and human operation, maintaining safety in conditions where autonomous systems may not be fully reliable.

For example, a minimum risk maneuver (MRM) function may comprise a critical safety feature in semi-autonomous and/or autonomous vehicles, designed to safely manage situations if a driver is unresponsive or the vehicle encounters a system failure. If the MRM function activates, a vehicle may automatically take control and perform a series of actions aimed at minimizing risk to a driver, passengers, and/or surrounding traffic. For example, this may involve gradually slowing down, signaling to other drivers with hazard lights, and/or moving the vehicle towards a safe position. The MRM function may be useful in cases where the driver fails to respond to a Transition Demand (TD) alert, ensuring that the vehicle comes to a controlled stop in a safe location.

For example, an emergency maneuver (EM) function may comprise a high-level safety feature in autonomous and/or semi-autonomous vehicles, designed to respond to sudden, critical situations where immediate action is required to avoid an imminent collision or danger. If the vehicle detects an emergency (e.g., a rapidly approaching obstacle or an unexpected hazard on the road), the EM function may automatically take control, performing evasive actions such as rapid braking, swerving, or accelerating to maneuver the vehicle away from the threat.

According to an example, the processor 110 may determine whether the body of the user comes into contact with the warmer or there is a risk that the body of the user will come into contact with the warmer, depending on the movement of the user, controlling the temperature of the warmer. For example, the processor 110 may perform control for reducing the temperature of the warmer with which the body of the user comes into contact or there is a risk that the body of the user will come into contact. For example, if the knees of the user come into contact with the door trim, the processor 110 may reduce the temperature of the warmer located in the door trim.

According to an example, the processor 110 may perform control for reducing the temperature of the warmer with which the body of the user continuously comes into contact or the temperature of the warmer with which the body of the user comes into contact in a certain pattern, depending on the posture of the user. For example, if the user drives with his or her right elbow placed on the console box, the processor 110 may reduce the temperature of the warmer located in the console box.

According to an example, the processor 110 may control the temperature of the at least one warmer, based on determining whether the event detected while the vehicle is driving is an event belonging to any of a plurality of risk levels divided according to a risk level of an accident occurring. The plurality of risk levels may include a first risk level, a second risk level, or a third risk level, or any combination thereof.

For example, the risk level of the accident occurring may be divided by a traffic accident, a road situation, a road type, weather, a driving habit of the driver, whether there are traffic lights, whether there is an intersection, a position of the vehicle, a driving time, or the like.

For example, the risk level of the accident occurring may be divided into the first risk level, the second risk level, and the third risk level.

For example, the first risk level may include a level (or an attention level) requiring the attention of the driver, the second risk level may include a level (or an emergency imminence level) in which an emergency is imminent, and the third risk level may include a level (or an emergency occurrence level) in which an emergency occurs. This is only an example. The risk level of the accident occurring may be divided to further include a risk level other than the first to third risk levels.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of controlling a temperature of at least one warmer) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of controlling a temperature of at least one warmer) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of controlling a temperature of at least one warmer) described herein.

Minimum risk maneuver (MRM) operation(s) may also be controlled, for example, based on one or more features (e.g., features of controlling a temperature of at least one warmer) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of controlling a temperature of at least one warmer) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of controlling a temperature of at least one warmer) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

For example, while the vehicle is traveling in automation level LEVEL 2, if another vehicle at a rear side is detected, the processor 110 may determine the risk level as the first risk level. For example, while the vehicle is traveling in automation level LEVEL 3, if lane departure is detected, the processor 110 may determine the risk level as the second risk level.

According to an example, the processor 110 may determine the event detected while the vehicle is driving, based on at least one of the result of detecting the front of the vehicle, the result of detecting the side of the vehicle, the result of detecting the rear of the vehicle, whether the vehicle enters an intersection, the result of detecting a lane change of the vehicle, whether the user takes his or her hands off the steering wheel, the result of monitoring the user, or whether a special situation occurs, or any combination thereof.

For example, the processor 110 may detect the front, the side, or the rear of the vehicle, using a sensor loaded into the vehicle. Furthermore, the processor 110 may detect whether the vehicle enters an intersection and whether the vehicle makes a lane change, using the sensor loaded into the vehicle.

According to an example, the processor 110 may monitor the user, using the sensor loaded into the vehicle. For example, the processor 110 may determine whether the driver keeps his or her eyes on the road by means of the monitoring of the driver. The processor 110 may generate a warning notification or may execute a transition demand (TD) function, depending on whether the drivers keeps his or her eyes on the road.

According to an example, the processor 110 may detect various events other than the above-mentioned events, using the sensor loaded into the vehicle.

According to an example, the sensor may include one or more sensors. For example, the sensors may be attached to different positions of the vehicle. The sensors may face one or more different directions. For example, the sensors may be attached to the front, sides, rear, or roof of the vehicle to face directions, such as forward-facing, rear-facing, and side-facing.

For example, the sensor may be an image sensor such as a high dynamic range camera. For example, the sensor may include a non-visual sensor. For example, the sensor may include radio detection and ranging (RADAR), light detection and ranging (LiDAR), or an ultrasonic sensor, other than the image sensor.

For example, the sensor may include a yaw sensor, a roll sensor, a pitch sensor, a collision sensor, a wheel sensor, a speed sensor, a tilt sensor, a weight sensor, a heading sensor, a gyro sensor, a position module, a moving object forward/backward sensor, a battery sensor, a fuel sensor, a tire sensor, a steering sensor according to steering wheel rotation, a moving object internal temperature sensor, a moving object internal humidity sensor, an ultrasonic sensor, an illumination sensor, an accelerator pedal position sensor, or a brake pedal position sensor.

According to an example, the processor 110 may control the temperature of the at least one warmer, based on determining whether the function of the vehicle, which is executed according to the event, is the function belonging to any of the first risk level, the second risk level, and the third risk level.

For example, while the vehicle is traveling in automation level LEVEL 2, if level 1 of the FCW function is executed, the processor 110 may determine the risk level as the first risk level. For example, while the vehicle is traveling in automation level LEVEL 3, if the transition demand (TD) function is executed, the processor 110 may determine the risk level as the second risk level.

According to an example, the processor 110 may control the temperature of the at least one warmer in a first mode, based on that the event detected while the vehicle is driving belongs to the first risk level, may control the temperature of the at least one warmer in a second mode, based on that the event detected while the vehicle is driving belongs to the second risk level, or may control the system for controlling the temperature of the at least one warmer to be turned off, based on that the event detected while the vehicle is driving belongs to the third risk level.

For example, if the event belonging to the first risk level is detected or the function of the vehicle, which belongs to the first risk level, is executed, the processor 110 may control the temperature of the warmer in the first mode. For example, if the event belonging to the second risk level is detected or the function of the vehicle, which belongs to the second risk level, is executed, the processor 110 may control the temperature of the warmer in the second mode. if the event belonging to the third risk level is detected or the function of the vehicle, which belongs to the third risk level, the processor 110 may control the system for controlling the temperature of the warmer to be powered off.

According to an example, the first mode or the second mode may include control for reducing temperatures of all warmers. For example, a degree to which the temperature of the warmer is reduced in the first mode and a degree to which the temperature of the warmer is reduced in the second mode may be different from each other. For example, the temperature of the warmer after being controlled in the second mode by the processor 110 may be smaller than the temperature of the warmer after being controlled in the first mode by the processor 110.

According to an example, the processor 110 may reduce the temperature of the at least one warmer by a first predetermined value, based on controlling the temperature of the at least one warmer in the first mode.

For example, the first predetermined value may be set to a temperature value which needs to decrease the temperature of the warmer. For example, if the first predetermined value is 10 degrees, the processor 110 may control the warmer in the first mode to decrease the temperature of the warmer by the 10 degrees.

For example, the first predetermined value may be set to a percentage value which needs to decrease the temperature of the warmer. For example, if the first predetermined value is 10%, the processor 110 may control the warmer in the first mode to decrease the temperature of the warmer by 10% of a current operating temperature.

According to an example, the processor 110 may decrease the temperature of the at least one warmer to a first temperature, based on controlling the temperature of the at least one warmer in the first mode. In this case, the first temperature may be set to a temperature value the temperature of the warmer finally reaches. For example, if the first temperature is 40 degrees, the processor 110 may control the warmer in the first mode to control the warmer such that the temperature of the warmer becomes the 40 degrees.

According to an example, the processor 110 may decrease the temperature of the at least one warmer by a second predetermined value greater than the first predetermined value, based on controlling the temperature of the at least one warmer in the second mode.

According to an example, the second predetermined value may be set to a temperature value which needs to decrease the temperature of the warmer. Additionally or alternatively, the second predetermined value may be set to a percentage value which needs to decrease the temperature of the warmer.

In this case, the second predetermined value may be set to a value greater than the first predetermined value. For example, a temperature after decreasing from the current temperature of the warmer by the first predetermined value may be greater than a temperature after decreasing from the current temperature of the warmer by the second predetermined value. For example, if the first predetermined value and the second predetermined value are set to temperature values of the warmer, the first predetermined value may be 10 degrees and the second predetermined value may be set to 20 degrees. For example, if the first predetermined value and the second predetermined value are set to percentage values, the first predetermined value may be set to 10% and the second predetermined value may be set to 20%.

According to an example, the processor 110 may decrease the temperature of the at least one warmer to a second temperature smaller than the first temperature, based on controlling the temperature of the at least one warmer in the second mode. In this case, the second temperature may be set to a temperature value the temperature of the warmer finally reaches. For example, if the second temperature is 30 degrees, the processor 110 may control the warmer in the second mode to control the warmer such that the temperature of the warmer becomes the 30 degrees.

According to an example, the processor 110 may control the temperature of the at least one warmer, depending on the automation level of the vehicle and the event detected while the vehicle is driving or the function of the vehicle, which is executed according to the event. For example, the processor 110 may consider both i) the automation level of the vehicle and ii) the event detected while the vehicle is driving to control the temperature of the warmer.

For example, while the vehicle is traveling in automation level LEVEL 2, if detecting a vehicle at a rear side, the processor 110 may determine the risk level as the first risk level. The processor 110 may control the temperature of the warmer in the first mode, depending on determining the risk level as the first risk level.

For example, while the vehicle is traveling in automation level LEVEL 3, if the transition demand (TD) function is executed, the processor 110 may determine the risk level as the second risk level. The processor 110 may control the temperature of the warmer in the second mode, depending on determining the risk level as the second risk level.

For example, while the vehicle is traveling in automation level LEVEL 4, if the transition demand (EM) function is executed, the processor 110 may determine the risk level as the third risk level. The processor 110 may control the system for controlling the temperature of the warmer to be turned off, depending on determining the risk level as the third risk level.

According to an example, after controlling the temperature of the at least one warmer depending on the event, the processor 110 may return the temperature of the at least one warmer to a temperature before controlling the temperature of the warmer depending on the event, based on that an event belonging to at least one of the first risk level, the second risk level, or the third risk level, or any combination thereof is no longer detected.

For example, while the vehicle is traveling in automation level LEVEL 2, if another vehicle is detected at the rear side of the vehicle, the processor 110 may determine the risk level as the first risk level. At this time, if the first predetermined value of the temperature which decreases depending on the first mode is 10 degrees, the processor 110 may decrease the temperature of the warmer by 10 degrees. Thereafter, if the other vehicle is no longer detected at the rear side of the vehicle, the processor 110 may increase the temperature of the warmer again by 10 degrees.

For example, while the vehicle is traveling in automation level LEVEL 3, if the transition demand (TD) function is executed, the processor 110 may determine the risk level as the second risk level. At this time, if the first predetermined value of the temperature which decreases depending on the first mode is 20% and the temperature of the warmer is 100 degrees, the processor 110 may decrease the temperature of the temperature by 20 degrees corresponding to 20% of the 100 degrees. Thereafter, if the TD is no longer required, the processor 110 may increase the temperature of the warmer again by 20 degrees.

According to an example, the processor 110 may control the temperature of the at least one warmer to a third temperature, based on determining that the body of the user comes into contact with the at least one warmer depending on a body type of the user.

At this time, the third temperature may be set to a temperature at which the body of the user does not have a burn. For example, the third temperature may be set to a temperature smaller than a temperature set to increase the interior temperature of the vehicle.

According to an example, the processor 110 may control the temperature of the at least one warmer to the third temperature, based on determining that the user intentionally touches the body of the user with the at least one warmer.

For example, if the user touches his or her hand with the steering wheel or touches his knees with the door trim, the processor 110 may determine that the user intentionally comes into contact with the warmer. The processor 110 may control the temperature of the warmer located in the steering wheel to the third temperature or may control the temperature of the warmer located in the door trim to the third temperature.

According to an example, if the body of the user comes into contact with the at least one warmer depending on the body type of the user or the user intentionally touches the body of the user with the at least one warmer, the processor 110 may maintain the temperature of the warmer as the third temperature. For example, the processor 110 may control the warmer with which the body continuously comes into contact to maintain the temperature at which the body of the user does not have a burn.

According to an example, the processor 110 may temporarily control the temperature of the at least one warmer to a fourth temperature or may temporarily turn off the system for controlling the temperature of the at least one warmer, based on determining that the body of the user temporarily comes into contact with the at least one warmer.

For example, if the body of the user temporarily comes into contact with the warmer, the processor 110 may decrease the temperature of the warmer, such that the user does not momentarily have a burn. For example, the processor 110 may temporarily decrease the temperature of the warmer to the fourth temperature smaller than the third temperature.

For example, the processor 110 may temporarily turn off the system for controlling the temperature of the warmer, such that the user does not momentarily have a burn. The processor 110 may temporarily turn off the system for controlling the temperature of the warmer to suddenly decrease the temperature of the warmer.

According to an example, the processor 110 may control only the temperature of the warmer with which the body of the user comes into contact among the at least one warmer.

For example, the processor 110 may decrease only the temperature of the warmer with which the body of the user comes into contact or there is a risk that the body of the user will come into contact. At this time, the processor 110 may maintain the temperature of the warmer with which there is no risk that the body of the user will come into contact as a high temperature to properly control an interior temperature of the vehicle.

According to an example, the processor 110 may control the temperature of the at least one warmer, using at least one of a cooling fan, a blower, or compressed gas, or any combination thereof.

For example, the processor 110 may operate the cooling fan to inhale or exhale air, controlling the temperature of the warmer.

For example, the processor 110 may operate the blower to inhale or exhale air, controlling the temperature of the warmer.

For example, the processor 110 may turn off the system for controlling the temperature of the warmer and may exhaust compressed gas to cool the temperature of the warmer. For example, if the accident of the vehicle occurs or there is a need to emergently cool the warmer, the processor 110 may exhaust compressed gas to cool the temperature of the warmer.

According to an example, the processor 110 may control the temperature of the at least one warmer with which the body of the user comes into contact, based on at least one of lateral acceleration which occurs due to driving of the vehicle or longitudinal acceleration which occurs due to the driving of the vehicle, or any combination thereof.

According to an example, an inertial force or a centrifugal force may act on the user, depending on the driving environment of the vehicle. For example, lateral acceleration and longitudinal acceleration may occur due to the driving of the vehicle. The body of the user may be biased in a certain direction. In this case, the processor 110 may control the temperature of the warmer located in a direction in which the body of the user is biased.

According to an example, if the vehicle travels in automation level LEVEL 4, the user may not be involved in driving at all, in a state in which he or she sits with the seat reclined at an angle which makes it difficult for the user to keep his or her eyes on the road. Alternatively, if the vehicle travels in automation level LEVEL 4, the user may not be involved in driving at all, in a state in which he or she lies down on the seat. In this case, the processor 110 may control the temperature of the warmer located in the direction in which the body of the user is biased, based on the lateral acceleration and the longitudinal acceleration due to the driving of the vehicle.

According to an example, the processor 110 may control the temperature of the at least one warmer, based on a database in which information about the user is reflected.

According to an example, a frequency at which the body of the user comes into contact with the warmer may vary with the body type or posture of the user. For example, a large person may have a larger frequency at which his or her body comes into contact with the warmer than a small person. The processor 110 may maintain the temperature of the warmer with a large frequency at which the body of the user comes into contact with the warmer as a low temperature.

According to an example, the processor 110 may set the temperature of the at least one warmer, based on a database in which information about a temperature preferred by the user is accumulated. For example, the processor 110 may store the temperature of the warmer, which is set by the user, in the database. Furthermore, the processor 110 may store a temperature, which is differently set for each position or type of the warmer, in the database. The processor 110 may properly control the temperature of the warmer, using the information stored in the database.

According to an example, the processor 110 may set the temperature of the at least one warmer, based on at least one of a high-definition map, driving environment information, or weather, or any combination thereof. For example, the processor 110 may obtain the high-definition map, the driving environment information, or information associated with the weather from an external server.

For example, if the vehicle travels in an area with a low exterior temperature, based on the high-definition map, the processor 110 may increase the temperature of the warmer to a high temperature. For example, if interior humidity is large, based on weather, the processor 110 may increase the temperature of the warmer to adjust humidity.

For example, the processor 110 may control the temperature of the warmer, using rainfall information, snowfall information, sunrise information, sunset information, or the like.

According to an example, the processor 110 may identify the temperature of the warmer, which is preferred by the user, using data accumulated in a data storage system for automated driving (DSSAD) or vehicle customer relationship management (VCRM).

For example, a data storage system for automated driving (DSSAD) may comprise a specialized recording system in autonomous and/or semi-autonomous vehicles that may capture and store key operational data, for example, while the vehicle is in automated driving mode. For example, DSSAD may log critical details such as vehicle speed, braking and steering inputs, sensor data, and/or the status of automated systems. This data may be useful for understanding the events leading up to an incident, clarifying whether the driver or the automated system was in control at the time. For example, vehicle customer relationship management (VCRM) may comprise a

system designed to enhance the interaction and relationship between automotive manufacturers, dealers, and customers by collecting and analyzing data related to vehicle usage, customer preferences, and service needs. Through VCRM, manufacturers and dealerships gain insights into individual customer behaviors, preferences, and ownership experiences, allowing them to provide personalized services, targeted offers, and timely maintenance reminders.

For example, the processor 110 may determine an optimal temperature preferred by the user, using a frequency at which the user compulsorily turns on/off the system for controlling the temperature of the warmer.

The vehicle control apparatus 100 of FIG. 1 according to example may properly control the temperature of the warmer with regard to the autonomous driving function and the event detected while the vehicle is driving, ensuring the safety and convenience of the user at the same time.

FIG. 2 shows an example drawing showing a type of a warmer, a temperature of which is controlled by a vehicle control apparatus according to an example of the present disclosure.

According to an example, the warmer, the temperature of which is controlled by the vehicle control apparatus, may be located in various interior materials of a vehicle.

For example, the warmer may include a crash pad warmer 210 located in a crash pad for preventing various parts in the vehicle from being visible, an instep warmer 220 located in an interior material with which the instep of the user may come into contact, a door trim warmer 230 located in a door trim, a seatback warmer 240 located in a seatback, a floor warmer 250 located in an interior floor, an armrest warmer 260 located in an armrest of a seat, a console box warmer 270 located in a console box, a glass warmer 280 located in the glass of the vehicle, a glove box warmer located in a glove box, or the like. This is only an example, and the warmer may be located in various interior materials other than the above-mentioned example.

According to an example, the temperature of the warmer may be differently set according to a type or location of the warmer. For example, the crash pad warmer 210, the instep warmer 220, the seatback warmer 240, and the glove box warmer may be set to increase to a high temperature, and the door trim warmer 230, the console box warmer 270, and the floor warmer 250, and the armrest warmer 260 may be set to be maintained as a low temperature. This is only an example, and the temperature of the warmer may be set to be different from the above-mentioned example according to a driving situation, a system, a user, or the like.

FIG. 3 shows an example table in which an automation level of a vehicle is defined, in conjunction with a vehicle control apparatus according to an example of the present disclosure.

An autonomous vehicle refers to a vehicle which recognizes a driving environment by itself to determine risk, controls its driving route to minimize driving manipulation of a driver, and drives itself.

The autonomous vehicle refers to a vehicle capable of performing driving, steering, and parking without influence of persons and is focused on a vehicle in a state in which the ability to drive a vehicle (an autonomous driving technology) is developed to the highest level even without active control or monitoring of a driver, which may be the core foundation of the autonomous vehicle.

Referring to FIG. 3, the driving environment may be monitored by the driver in automation levels LEVELs 0 to 2. The driving environment may be monitored by the automated driving system in automation levels LEVELs 3 to 5.

The concept of autonomous vehicles currently on the market may include an intermediate automation level to a fully autonomous vehicle and may correspond to a goal-oriented concept premised on the mass production and commercialization of fully autonomous vehicles.

An autonomous driving control method according to an example of present disclosure is applicable to an autonomous vehicle corresponding to LEVEL 3 (conditional automation) in automation levels shown in FIG. 3, but is not necessarily limited thereto, and is applicable to an autonomous vehicle supporting a plurality of various automation levels.

An automation level of the autonomous vehicle may be classified as shown in a table of FIG. 3 on the basis of society of automotive engineers (SAE).

LEVELs 0 to 3 among the automation levels according to example of the present disclosure may include a state in which the driver is awake. In this case, a vehicle control apparatus may decrease sensitivity of a warmer and may control the temperature of the warmer to a low temperature if an event occurs (310).

LEVELs 4 and 5 among the automation levels according to example of the present disclosure may include a state in which the driver is not awake. In this case, the vehicle control apparatus may increase the sensitivity of the warmer and may power off the warmer if the event occurs (320).

In FIG. 3 according to example, the vehicle control apparatus may differently control the temperature of the warmer depending on the automation level, continuously ensuring the convenience and safety of the user, although the intervention of the user for driving of a vehicle differs.

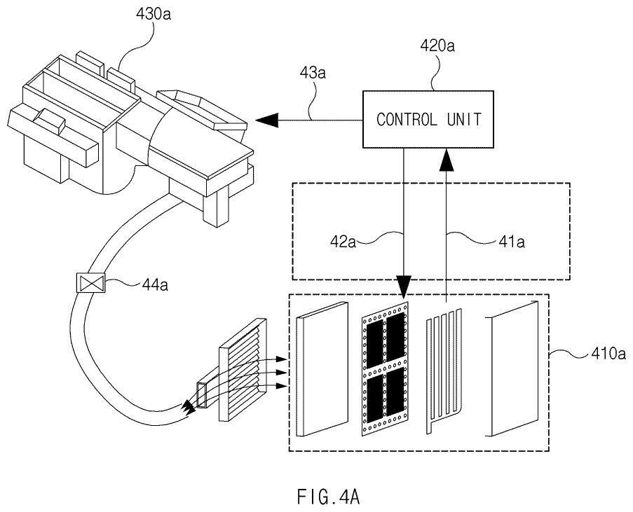

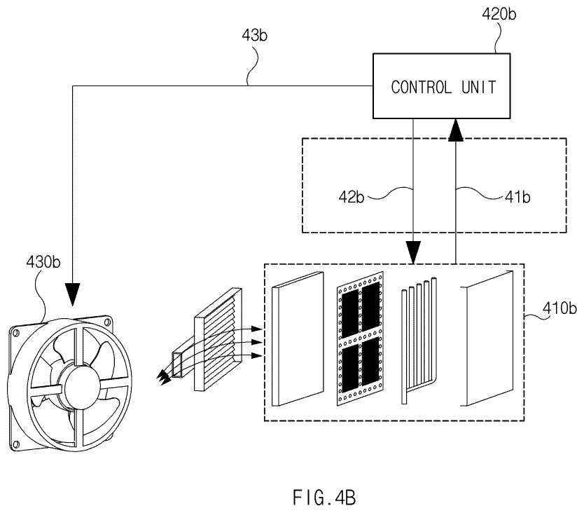

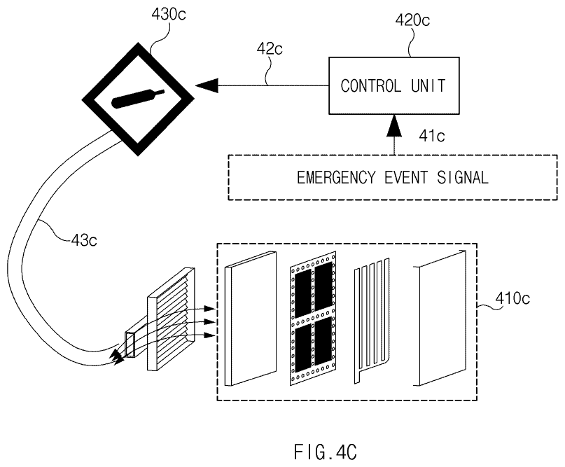

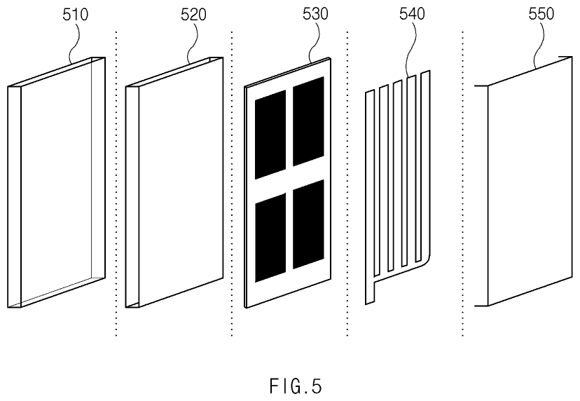

FIG. 4A shows an example drawing showing an example of controlling a temperature of a warmer using a blower in a vehicle control apparatus according to an example of the present disclosure.

According to an example, a blower 430a may include a part for moving air using a fan. For example, the blower 430a may include a blower for heating, ventilation, and air conditioning (HVAC).

According to an example, a control unit 420a may include a processor of the vehicle control apparatus.

According to an example, a warmer 410a may have a structure including an injection-molded material, an insulation layer, a heating element, a sensor, and a skin material.

According to an example, the warmer 410a may detect that the body of a user comes into the warmer 410a, using a sensor. The control unit 420a may identify that the body of the user comes into contact with the warmer 410a from the warmer 410a (41a). The control unit 420a may power off the warmer 410a, if necessary (42a). As the warmer 410a is powered off, the warmer 410a may be cooled. The control unit 420a may identify that the body of the user comes into contact with the warmer 410a to operate the blower 430a (43a). Air may be delivered to the warmer 410a depending on the operation of the blower 430a (44a). The temperature of the warmer 410a may decrease.

FIG. 4B shows an example drawing showing an example of controlling a temperature of a warmer using a cooling fan in a vehicle control apparatus according to an example of the present disclosure.

According to an example, a cooling fan 430b may include an individual cooling fan for moving air to an individual warmer.

According to an example, a control unit 420b may include a processor of the vehicle control apparatus.

According to an example, a warmer 410b may have a structure including an injection-molded material, an insulation layer, a heating element, a sensor, and a skin material.

According to an example, the warmer 410b may detect that the body of a user comes into the warmer 410b, using a sensor. The control unit 420b may identify the body of the user comes into contact with the warmer 410b from the warmer 410b (41b). The control unit 420b may power off the warmer 410b, if necessary (42b). As the warmer 410b is powered off, the warmer 410b may be cooled. The control unit 420b may identify that the body of the user comes into contact with the warmer 410b to operate the cooling fan 430b (43b). Air may be delivered to the warmer 410b depending on the operation of the cooling fan 430b. The temperature of the warmer 410b may decrease.

FIG. 4C shows an example drawing showing an example of controlling a temperature of a warmer using compressed gas in a vehicle control apparatus according to an example of the present disclosure.

According to an example, compressed gas 430c may include high-pressure gas capable of performing rapid cooling.

According to an example, a control unit 420c may include a processor of the vehicle control apparatus.

According to an example, a warmer 410c may have a structure including an injection-molded material, an insulation layer, a heating element, a sensor, and a skin material.

According to an example, the control unit 420c may identify that an emergency event signal is detected (41c). The control unit 420c may identify that the emergency event signal is detected, controlling the compressed gas 430c. As the compressed gas 430c is exhausted to the warmer 410c, the temperature of the warmer 410c may decrease.

FIG. 5 shows an example drawing showing an example of a structure of a warmer, a temperature of which is controlled by a vehicle control apparatus according to an example of the present disclosure.

According to an example, a warmer 410c may have a structure including an injection-molded material 510, an insulation layer 520, a heating element 530, a sensor 540, and a skin material 550.

According to an example, the injection-molded material 510 may be formed in a mounting structure capable of increasing rigidity of a warmer.

According to an example, the insulation layer 520 may serve to minimize that thermal energy is lost to the rear of the warmer.

According to an example, the heating element 530 may serve to convert electric energy into thermal energy and emit heat.

According to an example, the sensor 540 may serve to sense whether the body of the user comes into contact with the warmer.

According to an example, the skin material 550 may serve to form an exterior design of the warmer and reduce risk of burns to the body of the user.

The above-mentioned structure of the warmer is only an example, and the warmer may further include an additional configuration other than the above-mentioned configuration.

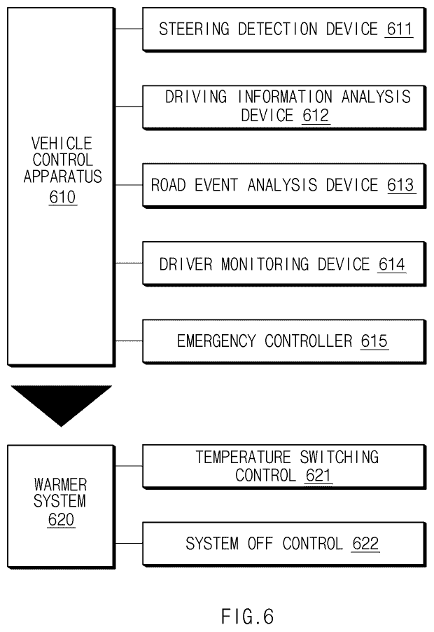

FIG. 6 shows an example block diagram showing a detailed example of a vehicle control apparatus and a warmer system according to an example of the present disclosure.

According to an example, a vehicle control apparatus 610 may include a steering detection device 611, a driving information analysis device 612, a road event analysis device 613, a driver monitoring device 614, and an emergency controller 615.

According to an example, the steering detection device 611 may detect whether a driver holds the steering wheel. The vehicle control apparatus 610 may indirectly determine a critical situation.

According to an example, the driving information analysis device 612 may determine a situation in which the risk of an accident increases due to the driving of a vehicle, such as an intersection entry situation or a lane change situation.

According to an example, the driving information analysis device 612 may determine a situation associated with emergency braking or lane departure due to forward collision-avoidance assist (FCA).

According to an example, the road event analysis device 613 may analyze an obstacle capable of being passed, an obstacle incapable of being passed, another vehicle, a traffic accident, road construction, a traffic congestion situation, an emergency vehicle, or the like.

According to an example, the driver monitoring device 614 may analyze a drowsy state of the driver or a posture of the driver in a state in which a function associated with autonomous driving operates. For example, the driver monitoring device 614 may determine whether the body of the user comes into contact with the warmer or how long the body of the user comes into contact with the warmer.

According to an example, the emergency controller 615 may determine whether to execute emergency stop in a lane, a minimum risk maneuver (MRM) function, or an emergency maneuver (EM) function.

According to an example, the vehicle control apparatus 610 may control a warmer system 620. For example, the vehicle control apparatus 610 may perform control for switching a temperature of a warmer, by means of the warmer system 620 (621). For example, the vehicle control apparatus 610 may perform control for powering off the warmer system 620, by means of the warmer system 620 (622).

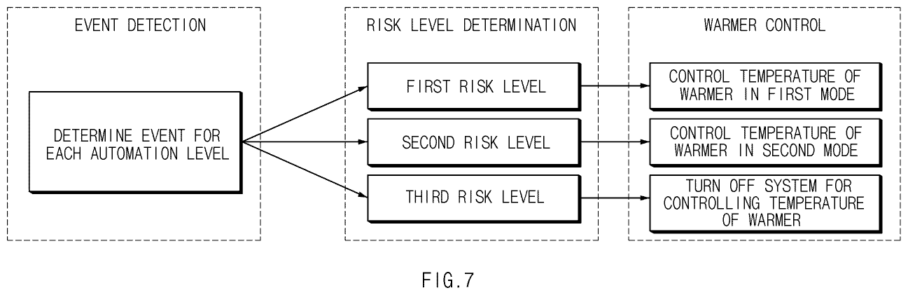

FIG. 7 shows an example drawing showing an example of a process of controlling a temperature of a warmer based on an event which occurs while a vehicle is driving in a vehicle control apparatus according to an example of the present disclosure.

According to an example, the vehicle control apparatus may detect an event which occurs while the vehicle is driving. The vehicle control apparatus may determine the detected event in conjunction with an automation level. For example, the range of the event detected by the vehicle control apparatus may vary for each automation level.

According to an example, the vehicle control apparatus may determine a risk level, based on the detected event. For example, the vehicle control apparatus may determine whether the detected event is an event belonging to any of a first risk level, a second risk level, or a third risk level.

According to an example, the vehicle control apparatus may differently control the temperature of the warmer depending on the risk level. For example, if the event belonging to the first risk level is detected, the vehicle control apparatus may control the temperature of the warmer in a first mode. For example, if the event belonging to the second risk level is detected, the vehicle control apparatus may control the temperature of the warmer in a second mode. For example, if the event belonging to the third risk level is detected, the vehicle control apparatus may power off a system for controlling the temperature of the warmer.

According to an example, the automation level, the first risk level, the second risk level, the third risk level, the first mode, or the second mode shown in FIG. 7 may be understood as the same meaning as the contents described with reference to FIG. 1.

Referring to FIG. 8, FIG. 9, and/or FIG. 10 according to example, the risk level may be divided into the first risk level (or an attention level), the second risk level (or an emergency imminence level), the third risk level (or an emergency occurrence level), and a risk release level.

FIG. 8 shows an example table showing an example of determining a risk level and a control strategy based on an event which occurs in automation level LEVEL 2 in a vehicle control apparatus according to an example of the present disclosure.

Referring to FIG. 8 according to example, the vehicle control apparatus may detect an exterior area of the vehicle, using a front sensor, a rear sensor, a side sensor, an ultrasonic sensor, a camera, or the like. For example, the vehicle control apparatus may detect the front of the vehicle, the rear of the vehicle, the side of the vehicle, whether the vehicle travels at an intersection, or whether the vehicle makes a lane change.

Referring to FIG. 8 according to example, the vehicle control apparatus may detect an interior area of the vehicle, using an indoor camera, a radar sensor, an ultrasonic sensor, or the like. For example, the vehicle control apparatus may detect whether the driver takes his or her hands off the steering wheel or may monitor a state of the driver.

According to an example, the function of the vehicle, which is executed according to the event which occurs in automation level LEVEL 2, may include a forward collision warning (FCW) function, a forward collision-avoidance assist (FCA) function, a blind spot collision warning (BCW) function, an advanced driver assistance systems (ADAS) function, a driver drowsiness and attention warning (DDAW) function, an emergency stop system (ESS) function, or a rear or side assisted steering function.

For example, a blind spot collision warning (BCW) function may comprise a safety feature in vehicles designed to alert drivers of vehicles or obstacles in their blind spots, which may be areas around the vehicle that may not be visible through mirrors alone. Using radar sensors that may be located on the side or rear of the vehicle, BCW may continuously monitor adjacent lanes to detect vehicles approaching from behind or lingering in the driver's blind spot.

For example, an advanced driver assistance systems (ADAS) function may comprise a technology designed to enhance vehicle safety and improve the driving experience by assisting drivers with various aspects of driving and accident prevention. ADAS may include a range of features, such as adaptive cruise control, lane-keeping assistance, blind-spot detection, forward collision warning, and automatic emergency braking.

For example, a driver drowsiness and attention warning (DDAW) function may comprise a safety feature designed to monitor a driver's alertness and provide warnings if signs of drowsiness or inattention are detected.

For example, an emergency stop system (ESS) function may comprise a critical safety feature in vehicles designed to bring a vehicle to a safe, controlled stop in cases where a driver is unresponsive or an emergency situation is detected.

For example, a rear or side assisted steering function may comprise an advanced vehicle feature that may enhance maneuverability and/or safety by adjusting the angle of the rear or side wheels in coordination with the front wheels.

According to an example, the event detected while the vehicle is driving in automation level LEVEL 2 may include another vehicle which is present in the rear or side, whether the vehicle enters an intersection, whether the vehicle makes a lane change, whether the driver responds, or whether the driver takes his or her hands off the steering wheel.

According to an example, if the vehicle enters the intersection, the vehicle control apparatus may determine a risk level as a first risk level and may control the temperature of the warmer in a first mode. After the vehicle enters the intersection, the vehicle control apparatus may release the first risk level and may normally operate the warmer.

According to an example, if the BCW function is executed, the vehicle control apparatus may determine the risk level as a second risk level and may control the temperature of the warmer in a second mode. If the situation in which the BCW function is executed is released, the vehicle control apparatus may release the second risk level and may normally release the warmer.

According to an example, if the ADAS function is turned off, the vehicle control apparatus may determine the risk level as a third risk level and may turn off a system for controlling the temperature of the warmer. If the ADAS function is resumed, the vehicle control apparatus may release the third risk level and may normally operate the warmer.

The above-mentioned example is only some of contents shown in FIG. 8. An example of various control strategies may be additionally described, based on FIG. 8.

FIG. 9 shows an example table showing an example of determining a risk level and a control strategy based on an event which occurs in automation level LEVEL 3 in a vehicle control apparatus according to an example of the present disclosure.

Referring to FIG. 9 according to example, the vehicle control apparatus may detect an exterior area of the vehicle, using a front sensor, a rear sensor, a side sensor, an ultrasonic sensor, a camera, or the like. For example, the vehicle control apparatus may detect the front of the vehicle, the rear of the vehicle, the side of the vehicle, whether the vehicle travels at an intersection, or whether the vehicle makes a lane change.

Referring to FIG. 9 according to example, the vehicle control apparatus may detect an interior area of the vehicle, using an indoor camera, a radar sensor, an ultrasonic sensor, or the like. For example, the vehicle control apparatus may monitor a state of a driver.

According to an example, the function of the vehicle, which is executed according to an event which occurs in automation level LEVEL 3, may include a forward collision-avoidance assist (FCA) function, a lane change process (LCP) function, a transition demand (TD) function, a minimum risk maneuver (MRM) function, or an emergency maneuver (EM) function.

According to an example, the event detected while the vehicle is driving in automation level LEVEL 3 may include whether there is another vehicle in a sensing range of a sensor, whether a safety distance from the other vehicle is ensured, whether the vehicle enters an intersection, or whether the vehicle departs from a lane.

According to an example, if there is the other vehicle in the sensing range of the sensor, the vehicle control apparatus may determine a risk level as a first risk level and may control a temperature of a warmer in a first mode. If there is no longer vehicle in the sensing range of the sensor, the vehicle control apparatus may release the first risk level and may normally operate the warmer.

According to an example, if the vehicle departs from the lane, the vehicle control apparatus may determine the risk level as a second risk level and may control the temperature of the warmer in a second mode. If the lane change is completed, the vehicle control apparatus may release the second risk level and may normally operate the warmer.

According to an example, if the MRM function is executed, the vehicle control apparatus may determine the risk level as a third risk level and may turn off a system for controlling the temperature of the warmer. If the attention of the driver is ensured, the vehicle control apparatus may release the third risk level and may normally operate the warmer.

The above-mentioned example is only some of contents shown in FIG. 9. An example of various control strategies may be additionally described, based on FIG. 9.

FIG. 10 shows an example table showing an example of determining a risk level and a control strategy based on an event which occurs in automation level LEVEL 4 or above in a vehicle control apparatus according to an example of the present disclosure.

Referring to FIG. 10 according to example, the vehicle control apparatus may detect an exterior area of a vehicle, using a front sensor, a rear sensor, a side sensor, an ultrasonic sensor, a camera, or the like. For example, the vehicle control apparatus may detect the front of the vehicle, the rear of the vehicle, the side of the vehicle, whether the vehicle travels at an intersection, whether the vehicle makes a lane change, an emergency, or a special situation.

According to an example, the function of the vehicle, which is executed according to an event which occurs in automation level LEVEL 4, may include a lane change process (LCM) function, a minimum risk maneuver (MRM) function, or an emergency maneuver (EM) function.

For example, a lane change process (LCM) function may comprise an advanced driver assistance feature designed to assist drivers in safely and smoothly changing lanes. Using sensors, radar, and cameras, the LCM system may monitor surrounding traffic and check for other vehicles in adjacent lanes, for example, in the driver's blind spots.

According to an example, the event detected while the vehicle is driving in automation level LEVEL 4 may include an object requiring attention, which is detected around a vehicle, (e.g., an obstacle capable of being passed, a traffic congestion situation, an emergency vehicle, or the like), a critical object detected around the vehicle (e.g., an obstacle incapable of being passed, another vehicle, a traffic accident, road construction, or the like), whether the vehicle enters an intersection, whether the vehicle departs from a line, a highway exit and entrance ramp, a tollgate, a boundary of an operational design domain (ODD), or whether the vehicle is abnormal.

According to an example, if the object requiring the attention is detected around the vehicle, the vehicle control apparatus may determine a risk level as a first risk level and may control a temperature of a warmer in a first mode. If the object requiring the attention is no longer detected around the vehicle, the vehicle control apparatus may release the first risk level and may normally operate the warmer.

According to an example, if abnormality is detected in the vehicle, the vehicle control apparatus may control the temperature of the warmer in a second mode. If the abnormality in the vehicle is no longer detected, the vehicle control apparatus may release the second risk level and may normally operate the warmer.

According to an example, if the MRM function is executed, the vehicle control apparatus may determine the risk level as a third risk level and may turn off a system for controlling the temperature of the warmer. If the attention of the driver is ensured, the vehicle control apparatus may release the third risk level and may normally operate the warmer.

The above-mentioned example is only some of contents shown in FIG. 10. An example of various control strategies may be additionally described, based on FIG. 10.

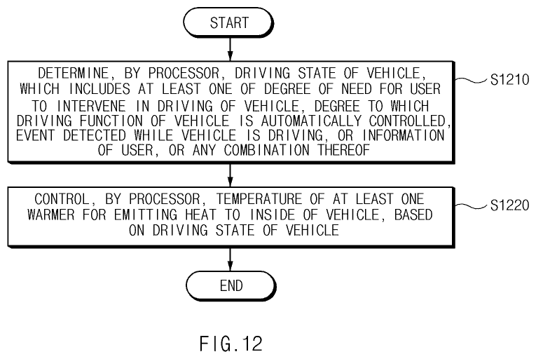

FIG. 11 shows an example drawing showing an example of a direction of acceleration capable of being considered if a vehicle control apparatus according to an example of the present disclosure controls a temperature of a warmer.

According to an example, if a vehicle travels in automation level LEVEL 4 or above, various types of rooms may be formed. In this case, users may use the vehicle in a state in which they sit on a seat that is reclined at an angle that makes it difficult for them to keep their eyes on the road or they lie down on a fully unfolded seat.

If the user uses the vehicle in a posture in which he or she does not completely recognize the driving situation ahead, the body of the user may come into contact with the warmer depending on a driving direction of the vehicle or shaking of the vehicle. There is a need to predict a direction in which the body of the user may be biased according to the driving of the vehicle and control the temperature of the warmer located in the predicted direction.

According to an example, lateral acceleration and longitudinal acceleration may occur depending on the driving of the vehicle.

According to an example, if the vehicle travels on a curved road, acceleration in a lateral direction 1111 according to the curved driving may occur (1110).

According to an example, if the vehicle makes a lane change or performs an evasive maneuver, acceleration in a lateral direction 1121 according to the lane change may occur (1120).

According to an example, if the vehicle suddenly stops, acceleration in a longitudinal direction 1131 may occur (1130).

According to an example, if the acceleration in the lateral direction or the acceleration in the longitudinal direction occurs, the body of the user may be biased in a specific direction.

For example, if the vehicle travels on the curved road, the body of the user may be biased in a lateral direction in which centrifugal force acts by the centrifugal force. In this case, the vehicle control apparatus may control the temperature of the warmer located in the direction in which the centrifugal force acts to a low temperature.

For example, if the vehicle suddenly stops, the body of the user may be biased in the longitudinal direction facing the front of the vehicle. In this case, the vehicle control apparatus may control the temperature of the warmer located in front of the user to a low temperature.

Based on FIG. 11 according to example, the vehicle control apparatus may predict a direction in which the body of the user may be biased according to the driving of the vehicle and may control the temperature of the warmer located in the predicted direction, promoting safety and convenience of the user.

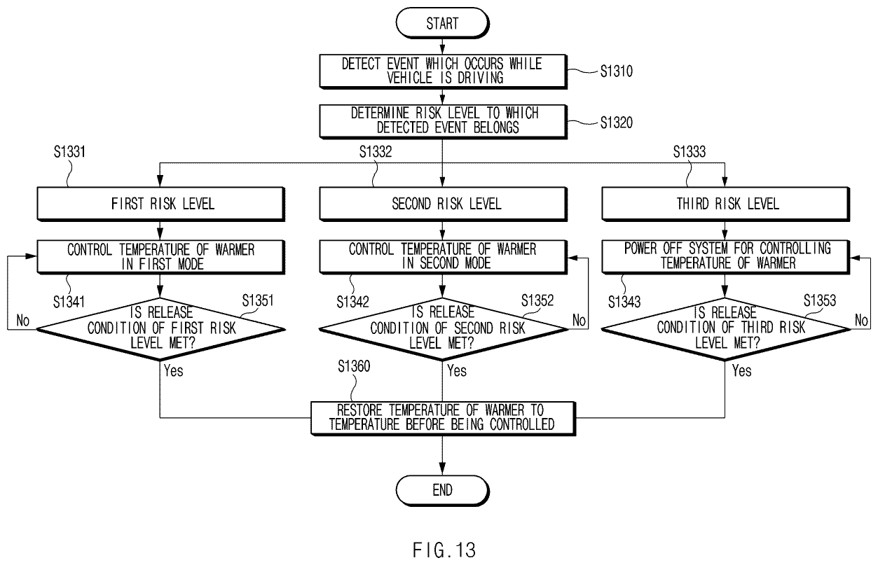

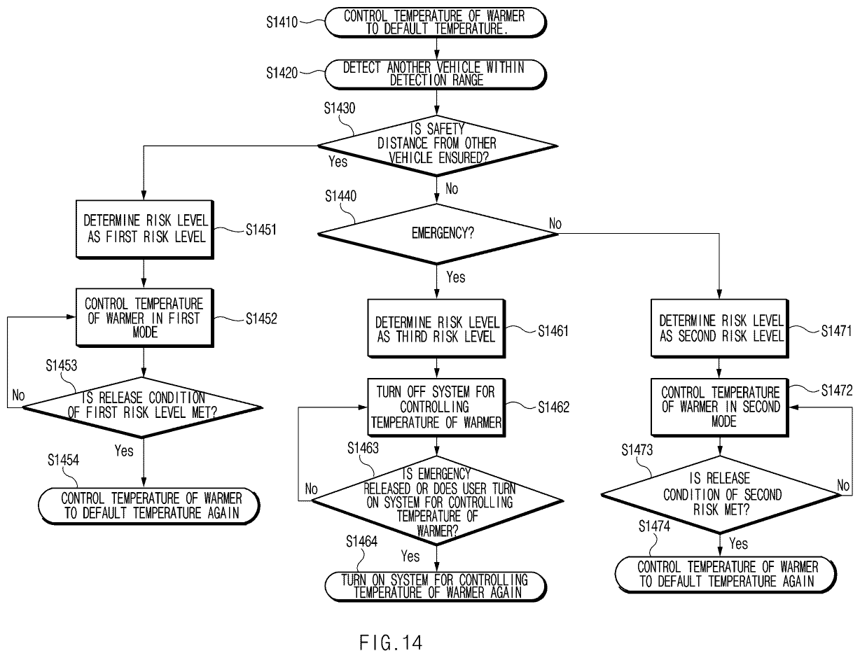

Hereinafter, a description will be given in detail of a vehicle control apparatus or a vehicle control method according to an example of the present disclosure with reference to FIG. 12, FIG. 13, and/or FIG. 14.

Hereinafter, a vehicle control apparatus 100 of FIG. 1 performs processes of FIG. 12, FIG. 13, and/or FIG. 14. Furthermore, in descriptions of FIG. 12, FIG. 13, and/or FIG. 14, an operation described as being performed by a vehicle control apparatus may be understood as being controlled by a processor 110 of the vehicle control apparatus 100.

FIG. 12 is a flowchart for describing a vehicle control apparatus or a vehicle control method according to an example of the present disclosure.

According to an example, in S1210, a processor may determine a driving state of a vehicle, which includes at least one of a need for a user to intervene in driving of a vehicle, a driving function of automatically controlled in the vehicle, an event detected while the vehicle is driving, or information of the user, or any combination thereof.

According to an example, in S1220, the processor may control a temperature of at least one warmer for emitting heat to the inside of the vehicle, based on the driving state of the vehicle.

FIG. 13 shows an example flowchart for describing an example of differently controlling a temperature of a warmer for each risk level, in conjunction with a vehicle control apparatus or a vehicle control method according to an example of the present disclosure.

According to an example, in S1310, the vehicle control apparatus may detect an event which occurs while a vehicle is driving, using a sensor. In S1320, the vehicle control apparatus may determine a risk level to which the detected event belongs.

For example, the vehicle control apparatus may determine whether the detected event belongs to a first risk level in S1331, may determine whether the detected event belongs to a second risk level in S1332, and may determine whether the detected event belongs to a third risk level in S1333.

According to an example, if the detected event belongs to the first risk level, in S1341, the vehicle control apparatus may control a temperature of a warmer in a first mode. In S1351, the vehicle control apparatus may determine whether a release condition of the first risk level is met. For example, if the event belonging to the first risk level is no longer detected, the vehicle control apparatus may determine that the release condition of the first risk level is met.

According to an example, if the release condition of the first risk level is met, in S1360, the vehicle control apparatus may restore the temperature of the warmer to a temperature before being controlled in the first mode.

According to an example, if the detected event belongs to the second risk level, in S1342, the vehicle control apparatus may control the temperature of the warmer in a second mode. In S1352, the vehicle control apparatus may determine whether a release condition of the second risk level is met. For example, if an event belonging to the second risk level is no longer detected, the vehicle control apparatus may determine that the release condition of the second risk level is met.

According to an example, if the release condition of the second risk level is met, in S1360, the vehicle control apparatus may restore the temperature of the warmer to a temperature before being controlled in the second mode.

According to an example, if the detected event belongs to the third risk level, in S1343, the vehicle control apparatus may power off a system for controlling the temperature of the warmer. In S1353, the vehicle control apparatus may determine whether a release condition of the third risk level is met. For example, if an event belonging to the third risk level is no longer detected, the vehicle control apparatus may determine the release condition of the third risk level is met.

According to an example, if the release condition of the third risk level is met, in S1360, the vehicle control apparatus may restart the system for controlling the temperature of the warmer.

FIG. 14 shows an example flowchart for describing a detailed example of differently controlling a temperature of a warmer for each risk level, in conjunction with a vehicle control apparatus or a vehicle control method according to an example of the present disclosure.

According to an example, in S1410, the vehicle control apparatus may control a temperature of a warmer to a default temperature. Herein, the default temperature may include a high temperature maintained to increase an interior temperature of a vehicle. Furthermore, the default temperature may vary with a position and a type of the warmer.

According to an example, in S1420, the vehicle control apparatus may determine whether another vehicle is detected within a detection range in the front, the rear, and the side of the vehicle. According to an example, in S1430, the vehicle control apparatus may determine whether a safety distance is ensured in a relationship with the other vehicle.

According to an example, if determining that the other vehicle is detected in the state in which the safety distance is ensured, in S1451, the vehicle control apparatus may determine a risk level as a first risk level. As the risk level is determined as the first risk level, in S1452, the vehicle control apparatus may control the temperature of the warmer in a first mode.

In S1453, the vehicle control apparatus may determine a release condition of the first risk level is met. For example, if an event belonging to the first risk level is no longer detected, the vehicle control apparatus may determine that the release condition of the first risk level is met.

According to an example, if the release condition of the first risk level is met, in S1454, the vehicle control apparatus may control the temperature of the warmer to the default temperature again.

According to an example, if determining that another vehicle is detected in a state in which the safety distance is not ensured, in S1440, the vehicle control apparatus may determine whether a current situation is an emergency. Herein, the emergency may include a situation in which a minimum risk maneuver (MRM) function or an emergency maneuver (EM) function is executed.

According to an example, if determining that the current situation is not the emergency, in S1471, the vehicle control apparatus may determine the risk level as a second risk level. As the risk level is determined as the second risk level, in S1472, the vehicle control apparatus may control the temperature of the warmer in a second mode.

In S1473, the vehicle control apparatus may determine a release condition of the second risk is met. For example, if an event belonging to the second risk level is no longer detected, the vehicle control apparatus may determine that the release condition of the second risk level is met.

According to an example, if the release condition of the second risk level is met, in S1474, the vehicle control apparatus may control the temperature of the warmer to the default temperature again.

According to an example, if determining that the current situation is the emergency, in S1461, the vehicle control apparatus may determine the risk level as a third risk level. As the risk level is determined as the third risk level, in S1462, the vehicle control apparatus may turn off a system for controlling the temperature of the warmer.

In S1463, the vehicle control apparatus may determine whether the emergency is released or a user turns on the system for controlling the temperature of the warmer.

According to an example, if the emergency is released or the user turns on the system for controlling the temperature of the warmer, in S1464, the vehicle control apparatus may turn on the system for controlling the temperature of the warmer again.

According to an aspect of the present disclosure, a vehicle control apparatus may include a memory storing a program instruction and a processor that executes the program instruction. The processor may control a temperature of at least one warmer for emitting heat to the inside of a vehicle, based on at least one of a need for a user to intervene in driving of the vehicle, a driving function of automatically controlled in the vehicle, an event detected while the vehicle is driving, or information of the user, or any combination thereof.

For example, the processor may control the temperature of the at least one warmer, based on determining whether the event detected while the vehicle is driving is an event belonging to any of a plurality of risk levels divided according to a risk level of an accident occurring.

For example, the processor may determine the event detected while the vehicle is driving, based on at least one of the result of detecting the front of the vehicle, the result of detecting the side of the vehicle, the result of detecting the rear of the vehicle, whether the vehicle enters an intersection, the result of detecting a lane change of the vehicle, whether the user takes his or her hands off the steering wheel, the result of monitoring the user, or whether a special situation occurs, or any combination thereof.

For example, the processor may control the temperature of the at least one warmer in a first mode, based on that the event detected while the vehicle is driving belongs to the first risk level, may control the temperature of the at least one warmer in a second mode, based on that the event detected while the vehicle is driving belongs to the second risk level, or may control a system for controlling the temperature of the at least one warmer to be turned off, based on that the event detected while the vehicle is driving belongs to the third risk level.

For example, the processor may decrease the temperature of the at least one warmer by a first predetermined value or decrease the temperature of the at least one warmer to a first temperature, based on controlling the temperature of the at least one warmer in the first mode, and may decrease the temperature of the at least one warmer by a second predetermined value greater than the first predetermined value or decrease the temperature of the at least one warmer to a second temperature smaller than the first temperature, based on controlling the temperature of the at least one warmer in the second mode.

For example, the processor may return the temperature of the at least one warmer to a temperature before controlling the temperature of the at least one warmer depending on the event, based on that the event belonging to at least one of the first risk level, the second risk level, or the third risk level, or any combination thereof is no longer detected, after controlling the temperature of the at least one warmer depending on the event.

For example, the processor may maintain the temperature of the at least one warmer as a third temperature, based on determining that a body of the user comes into contact with the at least one warmer depending on a body type of the user or determining that the user intentionally touches the body of the user with the at least one warmer, or may temporarily control the temperature of the at least one warmer to a fourth temperature or may temporarily turn off a system for controlling the temperature of the at least one warmer, based on determining that the body of the user temporarily comes into contact with the at least one warmer.

For example, the processor may control a temperature of a warmer with which the body of the user comes into contact among the at least one warmer.

For example, the processor may control the temperature of the at least one warmer, using at least one of a cooling fan, a blower, or compressed gas, or any combination thereof.

For example, the processor may control the temperature of the at least one warmer with which a body of the user comes into contact, based on at least one of lateral acceleration occurring by driving of the vehicle or longitudinal acceleration occurring by the driving of the vehicle, or any combination thereof.

For example, the processor may set the temperature of the at least one warmer, based on a database in which information about a temperature preferred by the user is accumulated.

For example, the processor may set the temperature of the at least one warmer, based on at least one of a high-definition map, driving environment information, or weather, or any combination thereof.

For example, the processor may identify an automation level of the vehicle among a plurality of automation levels, based on at least one of the need for the user to intervene in the driving of the vehicle or the driving function of automatically controlled in the vehicle, or any combination thereof.

For example, the processor may control the temperature of the at least one warmer to be turned off, based on at least one of a need for a user to intervene in driving of the vehicle, a driving function of automatically controlled in the vehicle, an event detected while the vehicle is driving, or information of the user, or any combination thereof.

According to another aspect of the present disclosure, a vehicle control method may include determining, by a processor, a driving state of a vehicle, the driving state including at least one of a need for a user to intervene in driving of the vehicle, a driving function of automatically controlled in the vehicle, an event detected while the vehicle is driving, or information of the user, or any combination thereof, and controlling, by the processor, a temperature of at least one warmer for emitting heat to the inside of the vehicle, based on the driving state of the vehicle.

In the vehicle control method according to an example, the controlling of the temperature of the at least one warmer for emitting the heat to the inside of the vehicle, based on the driving state of the vehicle, by the processor may include controlling, by the processor, the temperature of the at least one warmer, based on determining whether the event detected while the vehicle is driving is an event belonging to any of a plurality of risk levels divided according to a risk level of an accident occurring.

In the vehicle control method according to an example, the controlling of the temperature of the at least one warmer for emitting the heat to the inside of the vehicle, based on the driving state of the vehicle, by the processor may include determining, by the processor, the event detected while the vehicle is driving, based on at least one of the result of detecting the front of the vehicle, the result of detecting the side of the vehicle, the result of detecting the rear of the vehicle, whether the vehicle enters an intersection, the result of detecting a lane change of the vehicle, whether the user takes his or her hands off the steering wheel, the result of monitoring the user, or whether a special situation occurs, or any combination thereof.

In the vehicle control method according to an example, the controlling of the temperature of the at least one warmer, based on determining whether the event detected while the vehicle is driving is the event belonging to the plurality of risk levels divided according to the risk level of the accident occurring by the processor may include controlling, by the processor, the temperature of the at least one warmer in a first mode, based on that the event detected while the vehicle is driving belongs to the first risk level, controlling, by the processor, the temperature of the at least one warmer in a second mode, based on that the event detected while the vehicle is driving belongs to the second risk level, or controlling, by the processor, a system for controlling the temperature of the at least one warmer to be turned off, based on that the event detected while the vehicle is driving belongs to the third risk level.

In the vehicle control method according to an example, the controlling of the temperature of the at least one warmer in the first mode, based on that the event detected while the vehicle is driving belongs to the first risk level, by the processor may include decreasing, by the processor, the temperature of the at least one warmer by a first predetermined value or decreasing, by the processor, the temperature of the at least one warmer to a first temperature, based on controlling the temperature of the at least one warmer in the first mode. The controlling of the temperature of the at least one warmer in the second mode, based on that the event detected while the vehicle is driving belongs to the second risk level, by the processor may include decreasing, by the processor, the temperature of the at least one warmer by a second predetermined value greater than the first predetermined value or decreasing, by the processor, the temperature of the at least one warmer to a second temperature smaller than the first temperature, based on controlling the temperature of the at least one warmer in the second mode.

In the vehicle control method according to an example, the controlling of the temperature of the at least one warmer for emitting the heat to the inside of the vehicle, based on the driving state of the vehicle, by the processor may include maintaining, by the processor, the temperature of the at least one warmer as a third temperature, based on determining that a body of the user comes into contact with the at least one warmer depending on a body type of the user or determining that the user intentionally touches the body of the user with the at least one warmer, or temporarily controlling, by the processor, the temperature of the at least one warmer to a fourth temperature or temporarily turning off, by the processor, a system for controlling the temperature of the at least one warmer, based on determining that the body of the user temporarily comes into contact with the at least one warmer.

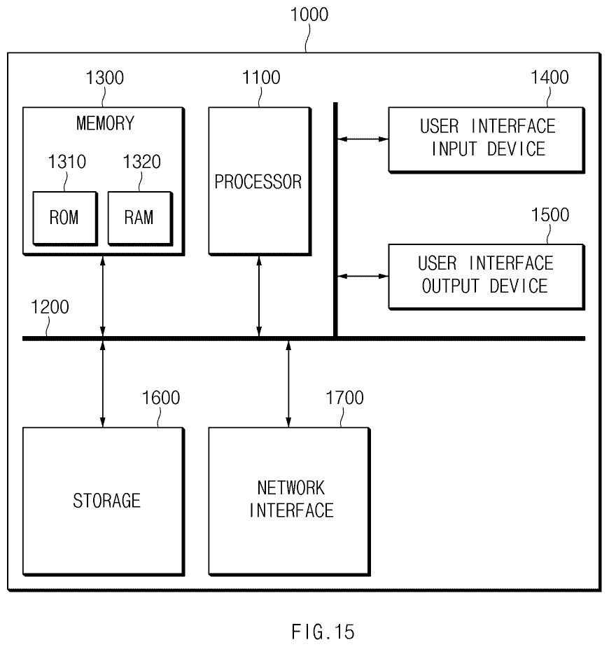

FIG. 15 shows an example drawing showing a computing system associated with a vehicle control apparatus or a vehicle control method according to an example of the present disclosure.

Referring to FIG. 15, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may decrease a temperature of a warmer with which the body of the user may come into contact, depending on an automation level while the vehicle is traveling and an event which occurs while the vehicle is traveling, preventing the user from contacting the body with the warmer at a high temperature and having a burn.

Furthermore, the present technology may control the temperature of the warmer with which the body of the user may come into contact, depending on a body type of the user, an intention of the user, or a change in posture of the user, providing the user with comfort.

Furthermore, the present technology may properly control the temperature of the warmer, depending on the automation level while the vehicle is traveling and the event which occurs while the vehicle is traveling, to create a pleasant indoor environment.

Furthermore, the present technology may automatically control the temperature of the warmer depending on a driving situation, operating the temperature of the warmer as a high temperature in a situation in which a special event does not occur.

Furthermore, the present technology may adjust the temperature of the warmer, depending on the automation level while the vehicle is traveling and the event which occurs while the vehicle is traveling, complying with regulations associated with autonomous driving.

Additionally or alternatively, various effects ascertained directly or indirectly through the present disclosure may be provided.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
a memory storing a program instruction; and
a processor configured to execute the program instruction to cause the vehicle control apparatus to:
during autonomous driving of a vehicle, detect, based on sensing data received from at least one sensor of the vehicle, a satisfaction of a temperature adjustment condition of at least one warmer installed in the vehicle, wherein the satisfaction of the temperature adjustment condition of the at least one warmer is detected based on at least one of:
a need for a user of the vehicle to intervene in driving of the vehicle;
a driving function of automatically controlled in the vehicle;
a traffic event detected while the vehicle is driving; or
pose information of the user; and
control, based on the detected satisfaction of the temperature adjustment condition, a temperature of the at least one warmer, wherein the at least one warmer is configured to transfer heat to an inside of the vehicle.

2. The vehicle control apparatus of claim 1, wherein the processor is configured to control the temperature of the at least one warmer by:
controlling the temperature of the at least one warmer, based on the traffic event being a traffic event associated with one of a plurality of risk levels, wherein the plurality of risk levels are classified according to different risk levels of an expected accident.

3. The vehicle control apparatus of claim 1, wherein the processor is configured to:
detect the traffic event based on at least one of:
a detection result of a front side of the vehicle,
a detection result of lateral sides of the vehicle,
a detection result of a rear side of the vehicle,
whether the vehicle enters an intersection,
a detection result of a lane change of the vehicle,
whether the user takes his or her hands off from a steering wheel, or
a detection result of monitoring the user.

4. The vehicle control apparatus of claim 2, wherein the processor is configured to:
control the temperature of the at least one warmer in a first mode, based on the traffic event corresponding to a first risk level of the plurality of risk levels;
control the temperature of the at least one warmer in a second mode, based on the traffic event corresponding to a second risk level of the plurality of risk levels; or
control a system for controlling the temperature of the at least one warmer to be turned off, based on the traffic event corresponding to a third risk level of the plurality of risk levels.

5. The vehicle control apparatus of claim 2, wherein the processor is configured to control the temperature of the at least one warmer by:
decreasing the temperature of the at least one warmer by a first predetermined value or decreasing the temperature of the at least one warmer to a first temperature, based on controlling the temperature of the at least one warmer in a first mode; and
decreasing the temperature of the at least one warmer by a second predetermined value greater than the first predetermined value or decreasing the temperature of the at least one warmer to a second temperature smaller than the first temperature, based on controlling the temperature of the at least one warmer in a second mode.

6. The vehicle control apparatus of claim 2, wherein the processor is configured to:
after controlling the temperature of the at least one warmer, adjust the temperature of the at least one warmer back to a temperature before controlling the temperature of the at least one warmer, based on the traffic event corresponding to at least one risk level of the plurality of risk levels being no longer detected.

7. The vehicle control apparatus of claim 2, wherein the processor is configured to:
maintain the temperature of the at least one warmer at a third temperature, based on at least one of: determining that a body of the user comes into contact with the at least one warmer depending on a body type of the user or determining that the user touches the body of the user with the at least one warmer; or
temporarily adjust the temperature of the at least one warmer to a fourth temperature or temporarily turn off a system for controlling the temperature of the at least one warmer, based on determining that the body of the user temporarily comes into contact with the at least one warmer.

8. The vehicle control apparatus of claim 2, wherein the processor is configured to control the temperature of the at least one warmer by:
controlling a temperature of a warmer with which a body of the user comes into contact among the at least one warmer.

9. The vehicle control apparatus of claim 2, wherein the processor is configured to control the temperature of the at least one warmer by:
controlling the temperature of the at least one warmer, using at least one of: a cooling fan, a blower, or compressed gas.

10. The vehicle control apparatus of claim 2, wherein the processor is configured to control the temperature of the at least one warmer by:
controlling the temperature of the at least one warmer with which a body of the user comes into contact, based on at least one of: lateral acceleration occurring by driving of the vehicle or longitudinal acceleration occurring by the driving of the vehicle.

11. The vehicle control apparatus of claim 2, wherein the processor is configured to:
set the temperature of the at least one warmer, based on a database in which information about a temperature preferred by the user is registered.

12. The vehicle control apparatus of claim 2, wherein the processor is configured to:
set the temperature of the at least one warmer, based on at least one of: information of a high-definition map, driving environment information, or weather information.

13. The vehicle control apparatus of claim 2, wherein the processor is configured to:
identify an automation level of the vehicle among a plurality of automation levels, based on at least one of: the need for the user to intervene in the driving of the vehicle or the driving function of automatically controlled in the vehicle.

14. The vehicle control apparatus of claim 1, wherein the processor is configured to:
control the temperature of the at least one warmer to be turned off, based on at least one of: a need for a user to intervene in driving of the vehicle, a driving function of automatically controlled in the vehicle, a traffic event detected while the vehicle is driving, or pose information of the user.

15. A vehicle control method performed by an apparatus of a vehicle, the method comprising:
determining a driving state of the vehicle;
during autonomous driving of the vehicle, detecting, based on sensing data received from at least one sensor of the vehicle, a satisfaction of a temperature adjustment condition of at least one warmer installed in the vehicle, wherein the satisfaction of the temperature adjustment condition of the at least one warmer is detected based on at least one of: a need for a user of the vehicle to intervene in driving of the vehicle, a driving function of automatically controlled in the vehicle, a traffic event detected while the vehicle is driving, or pose information of the user; and
controlling, based on the detected satisfaction of the temperature adjustment condition, a temperature of at least one warmer, wherein the at least one warmer is configured to transfer heat to an inside of the vehicle.

16. The vehicle control method of claim 15, wherein the controlling of the temperature of the at least one warmer comprises:
controlling the temperature of the at least one warmer, based on the traffic event being a traffic event associated with one of a plurality of risk levels, wherein the plurality of risk levels are classified according to different risk levels of an expected accident.

17. The vehicle control method of claim 15, wherein the controlling of the temperature of the at least one warmer comprises:
detecting the traffic event based on at least one of:
a detection result of a front side of the vehicle,
a detection result of lateral sides of the vehicle,
a detection result of a rear side of the vehicle,
whether the vehicle enters an intersection,
a detection result of a lane change of the vehicle,
whether the user takes his or her hands off from a steering wheel, or
a detection result of monitoring the user.

18. The vehicle control method of claim 16, wherein the controlling of the temperature of the at least one warmer comprises:
controlling the temperature of the at least one warmer in a first mode, based on the traffic event corresponding to a first risk level of the plurality of risk levels;
controlling the temperature of the at least one warmer in a second mode, based on the traffic event corresponding to a second risk level of the plurality of risk levels; or
controlling a system for controlling the temperature of the at least one warmer to be turned off, based on the traffic event corresponding to a third risk level of the plurality of risk levels.

19. The vehicle control method of claim 18, wherein the controlling of the temperature of the at least one warmer in the first mode comprises:
decreasing the temperature of the at least one warmer by a first predetermined value or decreasing the temperature of the at least one warmer to a first temperature, based on controlling the temperature of the at least one warmer in the first mode, and
wherein the controlling of the temperature of the at least one warmer in the second mode comprises:
decreasing the temperature of the at least one warmer by a second predetermined value greater than the first predetermined value or decreasing the temperature of the at least one warmer to a second temperature smaller than the first temperature, based on controlling the temperature of the at least one warmer in the second mode.

20. The vehicle control method of claim 15, wherein the controlling of the temperature of the at least one warmer comprises:
maintaining the temperature of the at least one warmer at a third temperature, based on at least one of: determining that a body of the user comes into contact with the at least one warmer depending on a body type of the user or determining that the user touches the body of the user with the at least one warmer; or
temporarily controlling the temperature of the at least one warmer to a fourth temperature or temporarily turning off a system for controlling the temperature of the at least one warmer, based on determining that the body of the user temporarily comes into contact with the at least one warmer.
